(19) United States
(12) Patent Application Publication
(10) Pub. No.: US 2024/0090689 A1
(43) Pub. Date: Mar. 21, 2024

(54) THIN, FUNCTIONAL, AND BIODEGRADABLE STRAWS AND METHODS OF MANUFACTURE THEREOF

(71) Applicant: Hearthmark, LLC, Greer, SC (US)

(72) Inventor: Saumitra Bhargava, Clarksville, MD (US)

(21) Appl. No.: 18/516,262

(22) Filed: Nov. 21, 2023

Related U.S. Application Data
(63) Continuation-in-part of application No. 17/648,195, filed on Jan. 18, 2022.
(60) Provisional application No. 63/140,550, filed on Jan. 22, 2021.

(51) Int. Cl. A47G 21/18; B29C 48/84

(52) U.S. Cl. CPC A47G 21/18; B29C 48/845; B29C 48/919

(57) ABSTRACT

Biodegradable drinking straws and methods of making biodegradable drinking straws. The drinking straws are thin and functional, having a tactile feel similar to conventional drinking straws, and are biodegradable in 12 months or less. The drinking straws use less material while maintaining high thickness uniformity, reducing cost and increasing structural integrity.

### CROSS-REFERENCE TO RELATED APPLICATIONS

This application is a Continuation-in-Part of U.S. patent application Ser. No. 17/648,195, filed Jan. 18, 2022, which claims priority to U.S. Provisional Patent Application No. 63/140,550, filed Jan. 22, 2021, both of which are hereby incorporated herein by reference in their entirety.

### FIELD OF THE DISCLOSURE

This disclosure relates generally to drinking straws and methods of making drinking straws and, in particular, relates to thin, functional, and biodegradable drinking straws and methods of making biodegradable drinking straws.

### BACKGROUND

Drinking straws have traditionally been formed from extruded polypropylene because of its high stiffness, low weight, and uniform thickness. Straws are typically manufactured by melting plastic pellets and pumping the melt through a die to form a tubular shape. After cutting to a specified length, the straw is obtained. The dimensions of the resulting straw, including wall thickness and thickness variability, vary based on process parameters such as extruder properties and dimensions, plastic melt viscosity, annular die dimensions, air supply pressure and flow rate, quench tank temperature, speed of belt puller, and speed of the rotating blade.

It is estimated that over 500 million plastic straws are used every day in the United States alone, with over 2,000 tons of plastic straws ending up in the ocean. While polypropylene is a recyclable material, drinking straws cannot be effectively recycled due to their low weight, thin form-factor, and tendency to trap contaminants that can ruin batches of recycled plastics. Furthermore, polypropylene does not decompose naturally in a reasonable amount of time.

The wholesale elimination of drinking straws is not a viable option to reducing plastic drinking straw waste because of medical conditions, such as multiple sclerosis, that prevent one from effectively consuming water and other beverages without using a drinking straw.

Alternatives to plastic straws have gained traction in recent years, including paper straws, reusable metal straws, straws made out of pasta, straws made out of wheat or grass, and straws made out of biodegradable materials. However, each of these straws suffer from some sort of deficiency. Paper straws disintegrate after only a short period of use. Metal straws feel foreign to most drinking straw users, are entirely opaque and prevent a visual analysis of their cleanliness, are difficult to clean because of their form-factor, and have proven to be dangerous, due to their rigidity, and ability to lance users. Pasta straws feel foreign to most drinking straw users, are remarkably thick, and disintegrate after a short period of use. Wheat or grass straws often include contaminants, and are expensive to produce. Currently available drinking straws made of biodegradable materials are typically much thicker than conventional polypropylene straws, have a higher thickness variation, and feel foreign to most drinking straw users.

Of the potential alternatives that would reduce plastic waste, biodegradable drinking straws have the greatest potential to replace conventional plastic drinking straws. However, biodegradable materials have processing parameters and material characteristics, such as melting point, crystallinity, and viscosity that make them difficult to adapt to conventional drinking straw production machines. To accommodate the different processing parameters required, manufacturers of biodegradable drinking straws have typically increased the thickness of the straws produced and/or increased the residence time. The resulting straws have a thickness of at least 6 mil and a high variability in thickness across the straw. The result is biodegradable drinking straws that weigh and cost more than conventional drinking straws, reducing the likelihood that they are commercially feasible to replace conventional drinking straws in their current form.

Accordingly, improved drinking straws are needed, as well as methods for manufacturing them, for overcoming one or more of the technical challenges described above.

### BRIEF DESCRIPTION OF THE DRAWINGS

The detailed description is set forth with reference to the accompanying drawings. The use of the same reference numerals may indicate similar to identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 is a schematic of a straw manufacturing machine in accordance with the present disclosure.

FIG. 2 is a boxplot of drinking straw thicknesses for a variety of drinking straws in accordance with the present disclosure.

FIGS. 3A-3B illustrate perspective and cross-sectional views, respectively, of one embodiment of a drinking straw according to the present invention.

### DETAILED DESCRIPTION

Drinking straws and methods of making drinking straws are provided herein including drinking straws and methods of making drinking straws that are thin, have low thickness standard deviation, are biodegradable via home compost in about 3 months, and look and feel like conventional polypropylene drinking straws. In particular, it has been discovered that drinking straws (i) produced from cellulose acetate, cellulose acetate propionate, cellulose acetate butyrate, or copolymers thereof, and (ii) produced using a naturally aspirated manufacturing process can satisfy most or all of the desirable characteristics of a conventional polypropylene drinking straw, e.g., in terms of cost effective, reliable manufacturing, dimensions, performance, and user appeal, yet are readily biodegradable in desirable time periods.

A lower thickness standard deviation corresponds to a narrower range of thicknesses across the straw. Since straw failure occurs at the weakest (i.e., thinnest) points along the straw, the thickness of the straw must be tuned so that the thinnest points are greater than a minimum viable thickness so as to avoid breakage or cracks. Conventional straws, therefore, have an average thickness that is significantly higher than the minimum viable thickness solely because the standard deviation is high. For example, 0.25 inch diameter straws, which is the most common straw diameter, typically have a wall thickness of between 5.5 mil to 8 mil. In contrast, the thickness of the straws described herein range from 3 mil to 5 mil without any loss in performance. Therefore, minimizing the standard deviation of the thickness of the straw enables a reduction in the overall thickness of the straw, which corresponds to less material usage, improved weight and feel to a consumer, and improved biodegradable properties.

In a preferred embodiment, the biodegradable drinking straw has a diameter of from about 0.22 inches (the standard consumer-grade straw diameter) to about 0.375 inches (more suitable for high viscosity beverages such as shakes). For example, the biodegradable drinking straw may have a diameter of 0.25 inches (the standard commercial-grade straw diameter), or the diameter may be 0.32 inches (suitable for medium-to-high viscosity beverages such as smoothies). Significantly, each straw has a sidewall thickness of from about 3 mil to about 5 mil, a thickness standard deviation of from about 0.19 mil to about 0.32 mil, and a thickness relative standard deviation of from about 1.9% to about 3.1%. This combination of diameter, wall thickness, and thickness standard deviation is a significant achievement in a straw formed from biodegradable material.

It is challenging to produce drinking straws with biodegradable polymeric materials using conventional extrusion processes and equipment, in part because many such materials will undergo significant degradation when heated and melted sufficiently to permit the material to be extruded to form the straw, particularly when attempting to produce straws having thin walls. However, it was discovered that conventional processes and equipment could be modified for natural aspiration, rather than the use of compressed air, to enable drinking straws made of cellulose acetate or cellulose acetate propionate in an extrusion process with a shorter residence time than conventional drinking straw production processes, enabling the drinking straw to be thinner and more uniform than other biodegradable straws while maintaining a familiar tactile feel and sufficient structural integrity.

Throughout this disclosure, various aspects are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6, etc., as well as individual numbers within that range, for example, 1, 2, 3, 4, 5, and 6. This applies regardless of the breadth of the range.

As used herein, the term “about” with reference to dimensions refers to the dimension plus or minus 10%.

### Biodegradable Drinking Straws

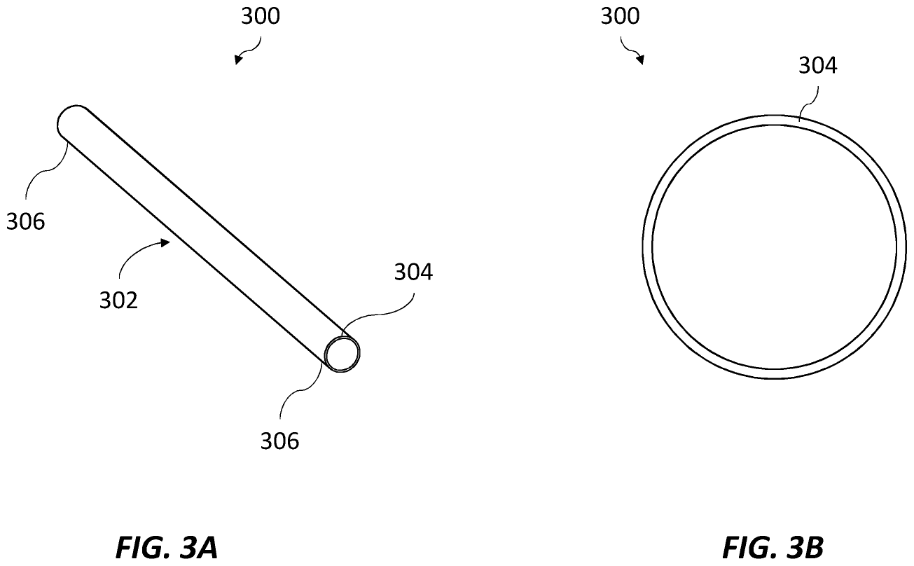

Biodegradable drinking straws are disclosed herein. An example of a biodegradable drinking straw is shown in FIGS. 3A-3B.

The drinking straws comprise at least cellulose acetate (CA) or cellulose acetate propionate (CAP) and are formed using a naturally aspirated manufacturing process. By forming the drinking straws out of cellulose acetate, cellulose acetate propionate, cellulose acetate butyrate, or copolymers thereof, the drinking straws are biodegradable. In some embodiments, the drinking straws consist or consist essentially of cellulose acetate (CA), cellulose acetate propionate (CAP), cellulose acetate butyrate (CAB), or copolymers thereof. The drinking straws optionally may include one or more coloring agents (e.g., colorants, fillers) or processing agents known in the art. The drinking straws have a thickness of from about 3.0 mil to about 5.5 mil and a diameter of from about 0.22 inches to 0.375 inches. The drinking straws have a thickness standard deviation of between about 0.19 mil to about 0.32 mil and a thickness relative standard deviation of between about 2% to about 3%. The drinking straws have a weight of between about 0.4 grams to about 0.7 grams.

As used herein, “naturally aspirated” refers to a straw manufacturing process that omits the use of compressed air in the annulus of the straw manufacturing machine. Conventional straw manufacturing machines and processes are characterized by the use of compressed air in the annulus. Omitting the compressed air requires either modification of the conventional machine or a custom machine. Thus, it has been unexpectedly discovered that natural aspiration of air which is driven into the center of the extruding plastic tube (i.e., the straw material after it has been formed into a cylinder but before it is cut) without pressurization by any mechanical pumps or other orifices that modify the air pressure.

As used herein, “biodegradable” refers to the ability for a material to decompose by microbial action in natural environments, e.g., in composting.

As used herein, the “thickness” of the drinking straw refers to the thickness of the side-wall that forms the characteristic cylindrical shape of the drinking straw.

As used herein, the “diameter” of the drinking straw is measured from the outside surface of the drinking straw, inclusive of the thickness of the drinking straw. That is, the diameter is the outer diameter of the straw.

In some embodiments, the drinking straw is certified as home compostable by TÜV (Technischer Überwachungsverein), a well-known conglomeration of companies that specializes in technical inspections, including the compostability of materials. The drinking straw home-composts in about 3 months. If discarded or disposed of in a manner that results in the drinking straw being placed in an outdoor environment, the drinking straw biodegrades in about 9 to 12 months.

In some embodiments, the drinking straw is transparent. In other embodiments, the drinking straw is translucent and has a colored tint. In still other embodiments, the drinking straw is opaque. Any suitable combination of color and transparency may be selected for the biodegradable drinking straws described herein without compromising on the biodegradability, thickness, or tactile feel of the drinking straws.

In some embodiments, the drinking straw retains its shape, structure, stiffness, and/or compressibility for at least 2 hours in a beverage container containing a beverage. In this way, the biodegradable drinking straws of the present disclosure improve on drinking straw alternatives such as paper straws and pasta straws.

In some embodiments, the drinking straw does not collapse under the pressure drop produced when a user sucks on an end of a straw when the opposing end is disposed in a viscous liquid, such as a smoothie or milkshake. In one example, the drinking straws disclosed herein pass the “McDonalds® milk shake test,” which involves drinking a medium milkshake from McDonalds® while observing whether the drinking straw collapses during use and by how much. Due to the high viscosity of milk-shakes, a large-diameter straw, around 0.3 inches, is often required in order to drink a milk shake through the straw without the straw collapsing. The biodegradable drinking straws of the present disclosure can be used for the consumption of milk shakes even with a diameter of from about 0.22 inches to about 0.375 inches and a thickness of from about 4 mil to about 5.5 mil. In contrast, both paper straws and polypropylene straws having a thickness of 5.5 mil fail the “McDonalds® milk shake test.”

In some embodiments, the drinking straw does not crack when manually depressed by a consumer. In other words, the drinking straw can be squeezed without forming cracks or holes. In contrast, alternative biodegradable drinking straws, such as those made from polylactic acid, will crack when manually depressed by a consumer.

FIGS. 3A-3B illustrate one embodiment of a drinking straw 300 according to the present disclosure. Drinking straw 300 includes a cylindrical body 302 having a sidewall 304 and opposed open ends 306, 306. Sidewall 304 has an annular cross-sectional shape.

### Methods of Making Biodegradable Drinking Straws

Methods of making biodegradable drinking straws are also described herein. In some embodiments, the method includes providing a straw manufacturing machine. The straw manufacturing machine includes one or more material sources, each configured to store a material.

As used herein, a “material” refers to one of the components that is combined to form the drinking straws. The CA and/or CAP resin is a “material.” Any coloring or additive to the CA/CAP resin is a “material.”

The straw manufacturing machine further includes an extruder configured to accept material from the one or more material sources at a first end of the extruder. The extruder includes a heated feed screw that is powered by a motor and is configured to feed the material from the first end of the extruder to a second end of the extruder. The extruder further includes a die, sometimes referred to as “tooling,” configured to shape the material as it exits the extruder.

The straw manufacturing machine further includes a cooling bath configured to cool extrudate exiting the extruder, and a cutter wheel configured to cut the extrudate into individual drinking straws.

In some embodiments, the method includes supplying a resin selected from CA, CAP, CAB, or copolymers thereof from one of the one or more material sources to the extruder. The resin is heated using the heated feed screw while being fed to the die. The method further includes extruding the resin through the die without the use of compressed air to produce an extrudate. In other words, the resin is naturally aspirated while extruding. The die preferably is configured to produce a cylindrical extrudate having a diameter of from about 0.22 inches to about 0.375 inches and a thickness of about 3.0 mil to about 5.5 mil. The die approximates the desired shape of the extrudate, but variations in the “gap” through which the resins passes may be necessary to ensure the extrudate has the desired shape and size after cooling. The extrudate may shrink by nearly an order of magnitude upon cooling. In some embodiments, the ratio of the desired straw thickness to the gap in the die is between about 0.1 to 0.125. For example, the ratio of the straw thickness to the gap in the die may be 0.1, 0.105, 0.11, 0.115, 0.12, 0.125, or any ratio therebetween.

In some embodiments, the method includes cooling the extrudate in the cooling bath. In some embodiments, the cooling bath has a temperature of 130° F. The method further includes cutting the cooled extrudate at regular intervals with the cutter wheel to produce drinking straws.

In some embodiments, the heated feed screw comprises a plurality of heating zones configured to heat the resin as it is fed from the first end of the extruder to the second end of the extruder. In other words, the heated feed screw has a lower temperature at the point where material or resin is fed into the extruder, and increased temperatures as the material or resin is fed towards the die on the extruder. In some embodiments, the heated feed screw comprises five heating zones in series having temperatures of 410/420/440/440/440° F.

In some embodiments, the heated feed screw is a low-work screw configured to minimize an amount of shear applied to the material as it is fed to the die. In other words, the low-work feed screw is designed to feed material or resin from the first end of the extruder, where the material enters the extruder from the one or more material sources, to the second end of the extruder, where the die is positioned, with minimal shear. This is accomplished by selecting a feed screw with fewer helical fins which have fewer rotations about a central axis of the feed screw.

In some embodiments, the residence time of the material or resin in the extruder is from about 1 minute to about 5 minutes, e.g., 2 to 3 minutes. The residence time of a material in an extruder having a particular temperature has significant effects on the material properties and the materials that can be processed. In applications in which thinner extrudate is desired, the residence time is typically increased. However, CA and CAP degrade when melted, so residence times such as those typical for polypropylene straw production (around 6 minutes) will result in degradation of the CA/CAP resin before any drinking straw is produced.

In some embodiments, the one or more material sources includes a source for a material configured to change a color of the drinking straws. For example, the material may be a solid or a liquid dye that is mixed with the CA and/or CAP to produce a colored resin in the extruder, and a colored drinking straw after extrusion and cutting.

In some embodiments, the method produces drinking straws having a thickness standard deviation of between about 0.19 mil to about 0.32 mil. As described above, the residence time for extrudate including CA and CAP must be low to prevent degradation of the CA/CAP resin, but should be increased in order to produce thinner extrudate. In order to produce an extrudate that is both thin and formed from CA and CAP, the die at the second end of the extruder must be custom tooled to produce a thin extrudate even though the residence time is shorter.

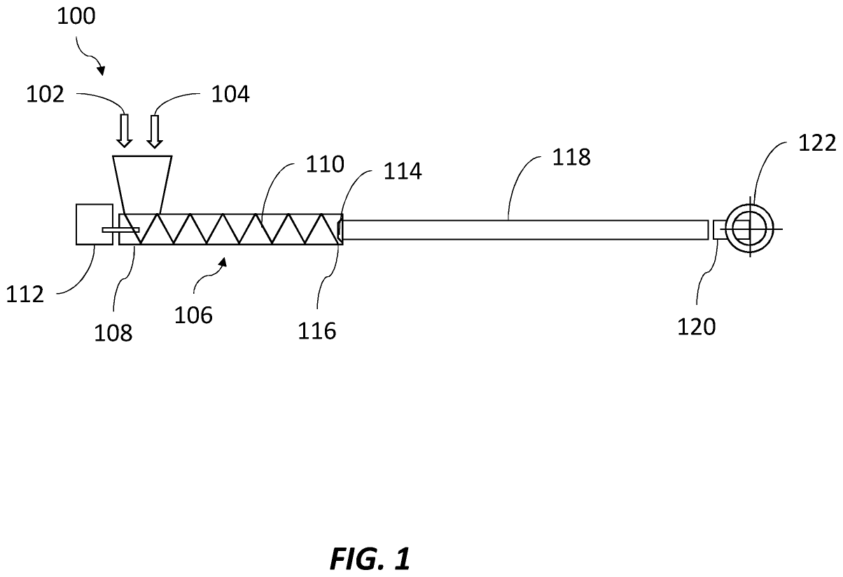

FIG. 1 is a schematic of a straw manufacturing machine 100 in accordance with the present disclosure. The straw manufacturing machine 100 includes a first material source 102 configured to supply resin and an optional second material source 104 configured to supply a colorant. The material sources 102, 104 supply material to an extruder 106 at a first end 108. Extruder 106 includes a heated feed screw 110 powered by a motor 112. Die 114 is located at a second end 116 of the extruder 106. Extrudate exiting the extruder enters the cooling bath 118 and is pulled through the bath by belt puller 120 before being cut into individual drinking straws by cutter 122.

### EXAMPLES

The invention may be further understood with reference to the following non-limiting examples.

### Example 1: Dimensions of Conventional Polypropylene Straws

Presented below in Table A are diameters and thicknesses of typical polypropylene drinking straws.

TABLE A
Dimensions of Polypropylene Drinking Straws

| | Diameter | Thickness |
|---|---|---|
| Use | (inches) | (mil) |
| School Milk/Juice Box | 0.125-0.13 | 3.5-4.5 |
| Jumbo Straws | 0.219-0.225 | 5.5-7 |
| Super Jumbo Straws | 0.25 | 6-7.5 |
| Giant Straws | 0.296-0.32 | 7-8.5 |

### Example 2: Biodegradable Drinking Straws

Biodegradable straws were produced using the methods as described herein. There were two material sources: one for CA/CAP resin and one for colorant. A single screw extruder was equipped with a low-work feed screw having a low filtration filter pack. The die had a mirror polish to reduce shear of the resin against the die during extrusion. The die also had a gap set to 0.035 inch for a 4.0 mil thick straw. A multipass cooling bath was used, having a temperature of 130° F. and a vacuum. The ratio of straw thickness to the gap was 0.114. The resins used were BlueRidge™ T160 Cellulosic Pellet (cellulose acetate propionate), available commercially from Celanese Corporation, Irving, Texas, USA; and FP1200 cellulose acetate with proprietary additives, available commercially from Eastman Chemical Company, Kingsport, Tennessee, USA.

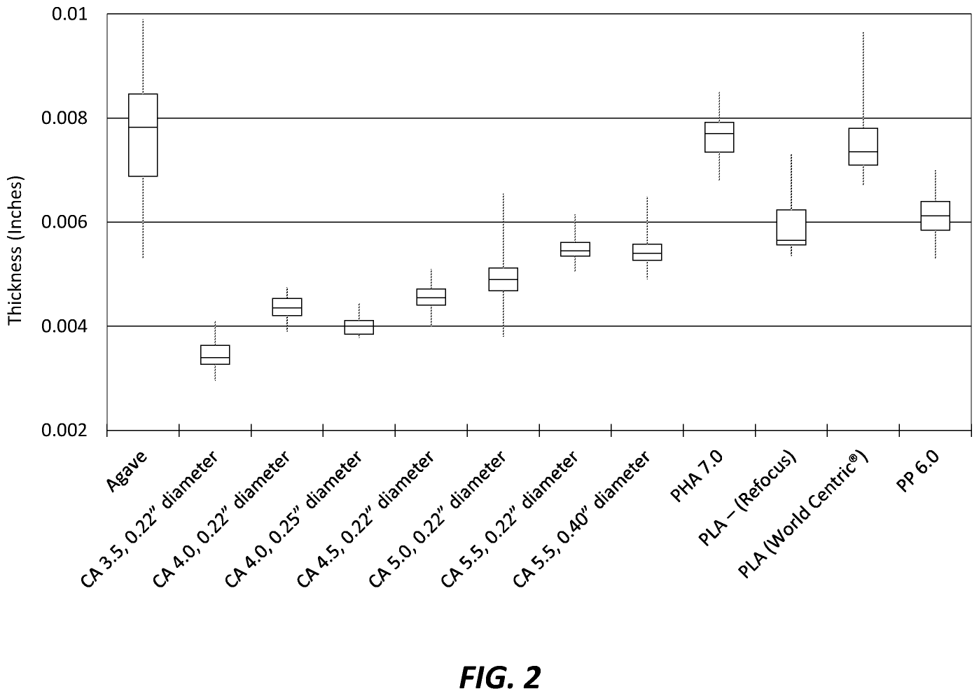

Presented below in Table B, and illustrated in FIG. 2, are thicknesses for 7 cellulose acetate drinking straws, 4 alternative biodegradable straws, and a polypropylene straw. The thickness of the sidewall is independent of drinking straw length. The cellulose acetate drinking straws had a diameter of 0.22 inches, 0.25 inches, or 0.40 inches as indicated in Table B and in FIG. 2; the polylactic acid (PLA) straw from Refocus, the polyhydroxyalkanoate (PHA) straw, and the polypropylene (PP) straws each had a diameter of 0.22 inches; and the PLA straw from World Centric® and the agave straw each had a diameter of 0.25 inches. The data for the cellulose acetate drinking straw having a diameter of 0.25 inches and a wall thickness target of 4.0 was were measured from a commercial production run over multiple days.

TABLE B
Thickness of Biodegradable Straws

| | Av- | | Min- | | Max- |
|---|---|---|---|---|---|
| | erage | Standard | imum | Median | imum |
| | thick- | Dev- | thick- | thick- | thick- |
| | ness | iation | ness | ness | ness |
| Straw Type | (inch) | (inch) | (inch) | (inch) | (inch) |
| Agave | 0.00767 | 0.001170 | 0.00530 | 0.00782 | 0.00990 |
| CA 3.5, 0.22″ diameter | 0.00345 | 0.000268 | 0.00295 | 0.00340 | 0.00410 |
| CA 4.0, 0.22″ diameter | 0.00437 | 0.000248 | 0.00390 | 0.00435 | 0.00475 |
| CA 4.0, 0.25″ diameter | 0.00398 | 0.000198 | 0.00378 | 0.00400 | 0.00445 |
| CA 4.5, 0.22″ diameter | 0.00456 | 0.000227 | 0.00400 | 0.00455 | 0.00510 |
| CA 5.0, 0.22″ diameter | 0.00490 | 0.000324 | 0.00380 | 0.00490 | 0.00655 |
| CA 5.5, 0.22″ diameter | 0.00548 | 0.000191 | 0.00505 | 0.00545 | 0.00615 |
| CA 5.5, 0.40″ diameter | 0.00542 | 0.000228 | 0.00490 | 0.00540 | 0.00650 |
| PHA 7.0 | 0.00763 | 0.000425 | 0.00680 | 0.00770 | 0.00850 |
| PLA-(Refocus) | 0.00590 | 0.000494 | 0.00535 | 0.00565 | 0.00730 |
| PLA (World Centric ®) | 0.00745 | 0.000521 | 0.00670 | 0.00735 | 0.00965 |
| PP 6.0 | 0.00612 | 0.000410 | 0.00530 | 0.00612 | 0.00700 |

### Example 3: Weight Comparison of Biodegradable Straws

Presented in Table C below are average weights of four different types of cellulose acetate drinking straws, polypropylene straws, and polyhydroxyalkanoate straws. All straws were 0.22 inches in diameter and 9.63 inches long. The thickness of the straws varied as described in Table B.

TABLE C
Weight of Biodegradable Straws

| Straw Type | Weight (grams) |
|---|---|
| CA 3.5 | 0.51 |
| CA 4.0 | 0.58 |
| CA 4.5 | 0.65 |
| CA 5.0 | 0.71 |
| PP 6.0 | 0.68 |
| PHA 7.0 | 0.85 |

Although the thicknesses of these straws vary, they have the same diameter and length. Thus, each would be readily substitutable for the other in practice. Because the drinking straws of the present invention have substantially lower weight when configured to have a thinner sidewall, the material use and corresponding material cost are substantially lower without sacrificing utility.

### Example 4: Comparison of Naturally Aspirated and Compressed Air Processes

Straws were formed as described herein, with some straws formed using the conventional manufacturing process that relies on compressed air, and some straws formed from a naturally aspirated process. The thickness of the wall of each straw was measured for each of the two types of straws and were compared to evaluate the differences between their standard deviations. Straws of 3 mil, 4 mil, and 5 mil average wall thickness were also made, both through the compressed air process and the naturally aspirated process, and the thickness standard deviations compared.

In order to evaluate the wall thickness, the straws were marked down their length using a felt tip pen during the manufacturing process to ensure that the straw orientation could be maintained between manufacturing and measurement. The measurement position around the straw was maintained regardless of the process or thickness. In another words, the marking is arbitrary; however, it ensures that measurements around the straw are performed consistently and helps eliminate any variations that can be attributed to the annular die.

Once removed from packaging, the conventionally-formed straws were cut down their lengths by passing a wooden dowel equipped with a razor blade at one end through the straw. This exposed the wall for measurement down the straw length. The straws were then cut into 1″ lengths for alignment and positioning on the measurement gauge anvil. The test system used to measure the straws was a Mitutoyo® Tube Thickness Measurement Gauge 547-561S augmented using a Mitutoyo® 937179T Foot Switch, and a Mitutoyo® USB Input Tool 264-016-10.

10 straws were evaluated: (1) cellulose acetate-based straw with 3 mil wall thickness, formed through naturally aspirated process, (2) cellulose acetate-based straw with 4 mil wall thickness, formed through naturally aspirated process, (3) cellulose acetate-based straw with 5 mil wall thickness, formed through naturally aspirated process, (4) cellulose acetate-based straw with 3 mil wall thickness, formed through compressed air process, (5) cellulose acetate-based straw with 4 mil wall thickness, formed through compressed air process, (6) cellulose acetate-based straw with 5 mil wall thickness, formed through compressed air process, (7) commercial polyhydroxyalkanoate based straw, (8) Konza Ware™ cellulose acetate straw, (9) Konza Ware™ Black cellulose acetate straw, and (10) D&W® Finepack cellulose acetate straw.

The straw wall thicknesses were measured in all 10 straws with each straw measured 6 times down its length. Measurements were taken 1 inch apart, and at least 1 inch from either end of a straw. This measurement procedure was repeated on the 6 groups of straws made under the two conditions—natural aspiration (“NA”) and compressed air (“COM”) with the three nominal thicknesses of 3 mil, 4 mil, and 5 mil. In all instances, the compressed air was applied at 15 psi. The results are displayed in Table D.

TABLE D
Comparison of Natural Aspiration and Compressed Air processes

| | | | Relative | | | | |
|---|---|---|---|---|---|---|---|
| | Average | Standard | Standard | Minimum | Maximum | 1st | 3rd |
| | thickness | Deviation | Deviation | Thickness | Thickness | quartile | quartile |
| Sample | (mm) | (mm) | (%) | (mm) | (mm) | (mm) | (mm) |
| 3 mil NA | 0.0783 | 0.00242 | 3.09 | 0.072 | 0.084 | 0.077 | 0.08 |
| 4 mil NA | 0.1032 | 0.00222 | 2.15 | 0.098 | 0.109 | 0.102 | 0.105 |
| 5 mil NA | 0.1347 | 0.00264 | 1.96 | 0.129 | 0.14 | 0.133 | 0.136 |
| 3 mil COM | 0.0778 | 0.00399 | 5.13 | 0.07 | 0.086 | 0.075 | 0.08 |
| 4 mil COM | 0.1069 | 0.00368 | 3.44 | 0.1 | 0.118 | 0.104 | 0.109 |
| 5 mil COM | 0.1315 | 0.00272 | 2.07 | 0.126 | 0.137 | 0.13 | 0.134 |
| PHA | 0.1411 | 0.00486 | 3.44 | 0.131 | 0.151 | 0.139 | 0.145 |
| Konza Ware ™ | 0.1692 | 0.00454 | 2.68 | 0.159 | 0.179 | 0.166 | 0.172 |
| Konza Ware ™ Black | 0.1494 | 0.00694 | 4.64 | 0.133 | 0.166 | 0.145 | 0.154 |
| D & W | 0.1657 | 0.0127 | 7.66 | 0.131 | 0.196 | 0.158 | 0.173 |

As shown in Table D, using a compressed air supply inside the die, extrudate, and straw tube at 15 psi produces a less uniform wall thickness than using natural aspiration. The standard deviation of wall thickness is a measure of uniformity of a straw or group of straws under specific manufacturing conditions. Examination of the difference in standard deviation between straw groups using compressed air and naturally aspirated reveals that significant differences exist between these two conditions, with lower standard deviation in wall thickness present in those straws produced using the naturally aspirated process described herein.

The use of naturally aspirated air supply is shown to produce superior straws with statistically significant improvements to thickness standard deviation compared to the use of compressed air in the die, extrudate, and straw tube during manufacture. Naturally aspirated air usage is therefore the recommended process for these straws. This finding is a valuable asset in manufacturing, which enables significant material cost savings through the production of thinner articles in production, and further enables improved production efficiency and the ability to run faster output without discontinuities, leading to additional cost savings. In fact, since some 0.25 inch diameter straws have a wall thickness of 8 mil, and the straws described herein may have a wall thickness of 3 mil to 5 mil, the material savings by improving thickness standard deviation may enable double the straw production from the same amount of material, without compromising the structural integrity or tactile feel.

Furthermore, as shown in Table D, the standard deviation of the thickness naturally decreases with increasing average thickness because thicker straw walls are easier to form consistently. Therefore, the relative standard deviation (RSD) is presented as a normalized value for standard deviation, enabling comparison of the standard deviation even for different average thicknesses. The straws formed as described herein have a RSD of less than about 3%, even at wall thicknesses of 3 mil, a value unachievable by 3 mil thick walls of straws formed using compressed air.

While the disclosure has been described with reference to a number of embodiments, it will be understood by those skilled in the art that the disclosure is not limited to such embodiments. Rather, the disclosure can be modified to incorporate any number of variations, alterations, substitutions, or equivalent arrangements not described herein, but which are commensurate with the spirt and scope of the disclosure. Conditional language used herein, such as “can,” “could,” “might,” or “may,” unless specifically stated otherwise, or otherwise understood within the context as used, generally is intended to convey that certain embodiments include, while other embodiments do not include, certain features, elements or functional capabilities. Additionally, while various embodiments of the disclosure have been described, it is to be understood that aspects of the disclosure may include only some of the described embodiments. Accordingly, the disclosure it not to be seen as limited by the foregoing described, but is only limited by the scope of the appended claims.

That which is claimed is:

1. A drinking straw comprising:
a cylindrical body having a sidewall disposed between opposed open ends, the sidewall having an annular cross-sectional shape,
wherein the drinking straw is manufactured in a process without the use of compressed air,
wherein the cylindrical body is formed of cellulose acetate, cellulose acetate propionate, cellulose acetate butyrate, or copolymers thereof,
wherein the sidewall has a thickness of from about 3.0 mil to about 5.5 mil with a thickness relative standard deviation of less than or about 3%, and
wherein the cylindrical body has an outer diameter of from about 0.22 inches to about 0.375 inches.

2. The drinking straw of claim 1, which has a weight of between about 0.4 grams to about 0.7 grams.

3. The drinking straw of claim 1, which is certified as home compostable by TÜV.

4. The drinking straw of claim 3, which is configured to home-compost in about 3 months.

5. The drinking straw of claim 1, which is configured to biodegrade in about 9 to 12 months when disposed in an outdoor environment.

6. The drinking straw of claim 1, which is transparent.

7. The drinking straw of claim 1, wherein the drinking straw is translucent and has a non-white color.

8. The drinking straw of claim 1, which is configured to retain its shape, structure, stiffness, and/or compressibility following immersion in an aqueous beverage for 2 hours.

9. The drinking straw of claim 1, which (i) does not collapse when used to drink a viscous beverage, and (ii) does not crack when manually depressed.

10. The drinking straw of claim 1, wherein the cylindrical body is formed of cellulose acetate and has an outer diameter of 0.22 inches, and the sidewall has a thickness from about 3.5 mil to about 4.5 mil.

11. A method of making drinking straws comprising:
providing a straw manufacturing machine comprising:
one or more material sources, each configured to store a material;
an extruder comprising a heated feed screw and a die, wherein the heated feed screw is powered by a motor, wherein the extruder is configured to accept material from the one or more material sources at a first end of the extruder, and wherein the heated feed screw is configured to feed the material from the first end of the extruder to a second end of the extruder;
a cooling bath configured to cool extrudate exiting the extruder; and
a cutter wheel,
supplying a resin selected from cellulose acetate, cellulose acetate propionate, cellulose acetate butyrate, or copolymers thereof from one of the one or more material sources to the heated feed screw;
heating the resin using the heated feed screw while feeding the resin to the die,
extruding the resin through the die without the use of compressed air to produce an extrudate, wherein the die is configured to produce a cylindrical extrudate having a diameter of from about 0.22 inches to about 0.375 inches, a thickness of about 3.0 mil to about 5.5 mil, and a thickness relative standard deviation of less than or about 3%,
cooling the extrudate in the cooling bath, and
cutting the cooled extrudate at regular intervals with the cutter wheel to produce drinking straws.

12. The method of claim 11, wherein the heated feed screw comprises a plurality of heating zones configured to heat the resin from the first end of the extruder to the second end of the extruder.

13. The method of claim 12, wherein the heated feed screw comprises five heating zones having temperatures of about 410/420/440/440/440° F.

14. The method of claim 11, wherein the heated feed screw is a low-work screw configured to minimize an amount of shear applied to the material as it is fed to the die.

15. The method of claim 11, wherein the cooling bath has a temperature of about 130° F. or higher.

16. The method of claim 11, wherein a residence time of the resin in the extruder is from about 1 minute to about 5 minutes.

17. The method of claim 11, wherein the one or more material sources further comprises a source for a material configured to change a color of the drinking straws.

18. The method of claim 11, wherein the drinking straws have a thickness standard deviation of between about 0.19 mil to about 0.32 mil.

19. The method of claim 11, wherein the die comprises a gap corresponding to the drinking straw, and wherein a ratio of the straw thickness to the gap is from about 0.1 to about 0.125.
